(19) United States
(12) Patent Application Publication
(10) Pub. No.: US 2007/0217593 A1
(43) Pub. Date: Sep. 20, 2007

(54) Method and apparatus for configuration of call forwarding through email or SMS messages

(75) Inventors: Gerald W. Pfleging, Batavia, IL (US); George Wilkin, Bolingbrook, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2579, US

(73) Assignee: Lucent Technologies Inc.

(21) Appl. No.: 11/377,043

(22) Filed: Mar. 16, 2006

(51) Int. Cl. H04M 3/42

(52) U.S. Cl. 379/211.02

(57) ABSTRACT

This disclosure is a method and system for the remote configuration of call forwarding. The method includes receiving an initiating transmission from a user, accessing an account that is associated with said user, and altering the call forwarding settings of said account. The initiating transmission may include, among other things, an e-mail or an SMS message, etc. The disclosure allows users to alter their call forwarding features from a remote location without having to assess the service provider's website.

### BACKGROUND OF THE INVENTION

This disclosure relates to a method and apparatus for call forwarding and, more particularly, to the method and system for the configuration of call forwarding through electronic mail (e-mail) or short messaging system (SMS) messages.

While the disclosure is particularly directed to the art of configuring call forwarding through email or SMS messages, in Voice over Internet Protocol (VOIP) installations, especially where the phone system has built in intelligence to handle such activities and thus will be described with specific reference thereto, it will be appreciated that the disclosure may have other useful fields of application. For example, the disclosure may be used for the configuration of call forwarding in traditional telephone systems.

By way of background, call forwarding is a system which allows a user to reroute incoming calls in order that the call will ring on another telephone, or like communication device. Customers and businesses often use this type of feature to ensure that they will not miss an important phone call when they are away from their primary phone. In this respect, a user can have telephone calls that are placed to his home telephone, ring at his business phone and/or mobile phone, etc. This feature is particularly useful when the customer is going to be out of town for long periods of time. By using this feature, the customers can have calls originally placed to their home numbers forwarded to wherever they are. (i.e. their cell phone, their hotel room, etc.) The customer can even have calls forwarded to a long distance telephone number and the customer would be the one to pay for the long distance charges, not the caller.

Although call forwarding is very convenient, often times customers does not know what phone number they would like the calls forwarded to until they arrive at their destination. For example, a customer could be leaving the country, and the customer wants calls forwarded to the hotel room. However, the customer may not know the hotel room's phone number until the destination is reached.

Therefore, there is a need in the industry for a call forwarding service that can be accessed from a remote location. Furthermore, there is a need in the industry for a system that will allow its customers access with minimal effort.

The present disclosure contemplates a new and improved system and method for resolving the above-referenced difficulties and more.

### SUMMARY OF THE INVENTION

A method and system for configuration of call forwarding through email or SMS messages is provided.

In one aspect of the presently described embodiments is a method of configuration of call forwarding comprising receiving an initiating transmission from a user, accessing an account that is associated with the user, and altering the call forwarding settings of the account.

In another aspect of the presently described embodiments includes replying the status of the account to the user.

In another aspect of the presently described embodiments includes implementing a “find me” features. Another aspect of the presently described embodiment includes implementing presence information.

In another aspect of the presently described embodiments, the method further includes receiving a short messaging system or e-mail from the user.

In another aspect of the presently described embodiments, the method includes receiving and initiating transmission that includes at least one time boundary for the call forwarding service.

In another aspect of the presently described embodiments, the method further includes receiving an initiating transmissions including at least one phone number or phone number identification where the call should be forwarded.

In another aspect of the presently described embodiments, the method includes verifying that the user is a subscriber to the service.

In another aspect of the presently described embodiments, the system includes a messaging server that is configured to receive initiating transmission requesting an alteration of call forwarding service settings, a control system module configured to parse the initiating transmission into components in order to determine parameters for the call forwarding feature, and a forwarding module that alters the call forwarding service settings.

In one aspect of the presently described embodiments, includes the initiating transmission being a short messaging system message or an e-mail message.

In another aspect of the presently described embodiments, the system includes a verification module configured to authenticate the transmission.

Further scope of the applicability of the present disclosure will become apparent from the detailed description provided below. It should be understood, however, that the detailed description and specific examples, while indicating preferred embodiments of the disclosure, are given by way of illustration only, since various changes and modifications within the spirit and scope of the invention will become apparent to those skilled in the art.

### DESCRIPTION OF THE DRAWINGS

The presently described embodiments exist in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1a illustrates a portion of the communications network including a public network, a network provider, a corporate phone system, a unified messaging service, two user lines, one which a call would be forwarded to and the other to be forwarded from.

FIG. 1b illustrates another embodiment of the communications network.

FIG. 1c illustrates another embodiment of the communications network.

FIG. 2 is a flow chart illustration of the method according to the present disclosure.

FIG. 3 illustrates a server module according to an embodiment of the present disclosure.

### DETAILED DESCRIPTION OF THE PREFERRED EMBODIMENTS

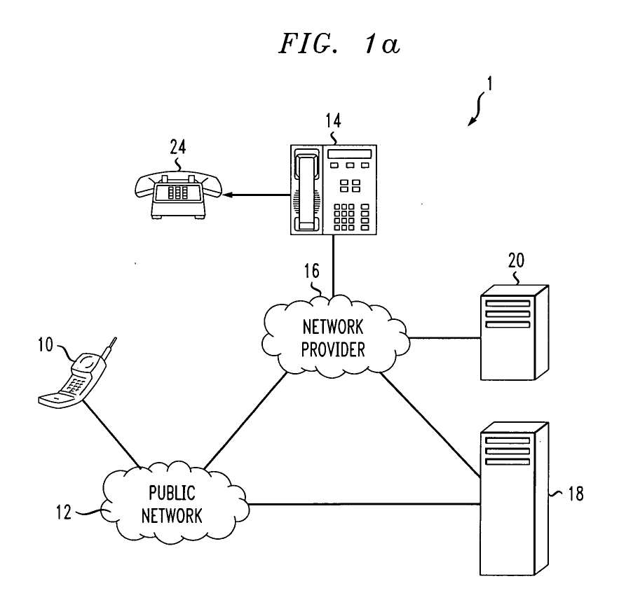

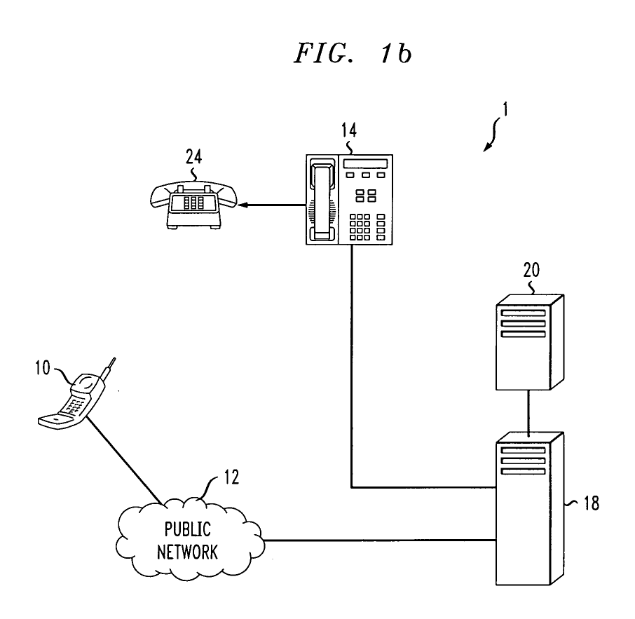

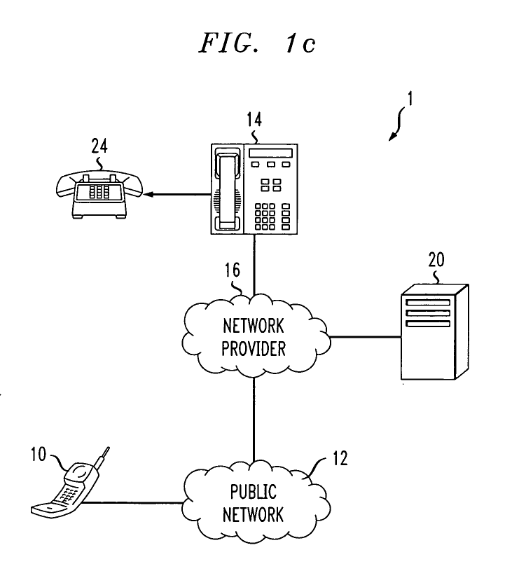

Referring now to the drawings wherein the showings are for purposes of illustrating the preferred embodiments of the invention only and not for purposes of limiting same, FIG. 1a provides a view of a system into which the present invention may be incorporated. A communications network infrastructure 1 is shown. The communication network infrastructure 1a includes an initiating message device 10, a public network 12, network provider 16, corporate phone system 18, a united messaging server 20, a first user line 14 and a second user line 24.

In operation, as described in greater detail below, the presently described embodiments include a method for configuration of call forwarding through e-mail or SMS messages. The method includes receiving an initiating transmission from a user, accessing an account associated with the user, and altering the call forwarding settings to the account.

Still referring to FIG. 1a, the initiating message device 10, could be a variety of different communication devices including, but not limited to, a wireless telephone, a VolP telephone, a laptop computer, a desk top computer, a Wi-Fi phone, etc. The communication device 10 sends an initiating transmission through the corresponding public network 12. This communication is then received either through the network provider 16 or through the corporation's phone system 18. This initiating transmission can be sent as an SMS message, an e-mail message, or any other acceptable means of communication.

he public network 12 is primarily operative as a support system in which the initiating transmission can be sent. The public network 12 can be a public switch telephone network (PSTN), an internet network, a cellular network, a hard wire network, or any other network capable of carrying the initiating transmission.

Still referring to FIG. 1a, a corporate phone system 18 is disclosed. The corporate phone system could be a VolP system, a Centrex system, a private branch exchange (PBX) and/or any other suitable telephone system that the subscriber has in place. In the exemplary embodiment, the corporate phone system 18 may receive this initiating transmission directly or through the network provider 16. The corporate phone system 18 then processes the initiating transmission and uses the information in order to determine in what circumstances the phone call will be forwarded. In determining the parameters in which call forwarding will be initiated, the initiating transmission can contain a variety of different considerations which are described in further detail below. In parsing the initiating transmission, the network provider 16 or corporate phone system 18 may defer to a unified messaging server 20. A unified messaging server 20 may include an SMS server, an e-mail server, an SMTP server, etc. This server 20 may incorporate SMS messaging, paper messaging, e-mail messaging, etc., or in the alternative, the communications network 1 can house some or all of these communication servers separately. Furthermore, this server 20 may assist in parsing the message, verifying the message, determining which call forwarding settings need to be changed and/or deactivating the call forwarding service.

Once the initiating message is received and the parameters determined, the network provider 16 may initiate call forwarding according to the initiating transmission's specifications. In which case, if a call comes in that is within the parameters set by the initiating transmission, the call would bypass the user's first line 14 and the call would go directly to the user's second line 24. As pictured in FIG. 1, the user's second line 24 can be different from that of the initiating message device 10. However, this is not necessarily the case. A user may to choose to forward his calls to the same device in which created the initiating transmission 10. Furthermore, a user may choose to transfer his calls to a variety of available lines, including but not limited to a Wi-Fi line, a VolP line, a traditional, wired, plain old telephone service (POTS) line or any another acceptable device.

Referring now to FIG. 1b, another embodiment of a communications network infrastructure 1b is shown. The communication network infrastructure 1 includes an initiating message device 10, a public network 12, corporate phone system 18, a united messaging server 20, a first user line 14 and a second user line 24.

In this embodiment, the communication device 10 sends an initiating transmission through the corresponding public network 12. This communication is then received through the corporate phone system 18. The corporate phone system 18 then processes the initiating transmission and uses the information in order to determine in what circumstances the phone call will be forwarded. It should be noted that in this embodiment, the network provider is not used in implementing the claimed method.

Referring now to FIG. 1c, another embodiment of a communications network infrastructure 1b is shown. The communication network infrastructure 1 includes an initiating message device 10, a public network 12, a provider's network 18, a united messaging server 20, a first user line 14 and a second user line 24.

In this embodiment, when the communication device 10 sends an initiating transmission the communication is received through the network provider 16. The network provider 16 processes the initiating transmission and uses the information in order to determine in what circumstances the phone call will be forwarded. In this embodiment, the claimed method is primarily implemented through the network provider 16 and not through the corporate phone system. These are but a few of the many possible network configuration, however, there are many hardware and software configurations in which the exemplary embodiment can be employed.

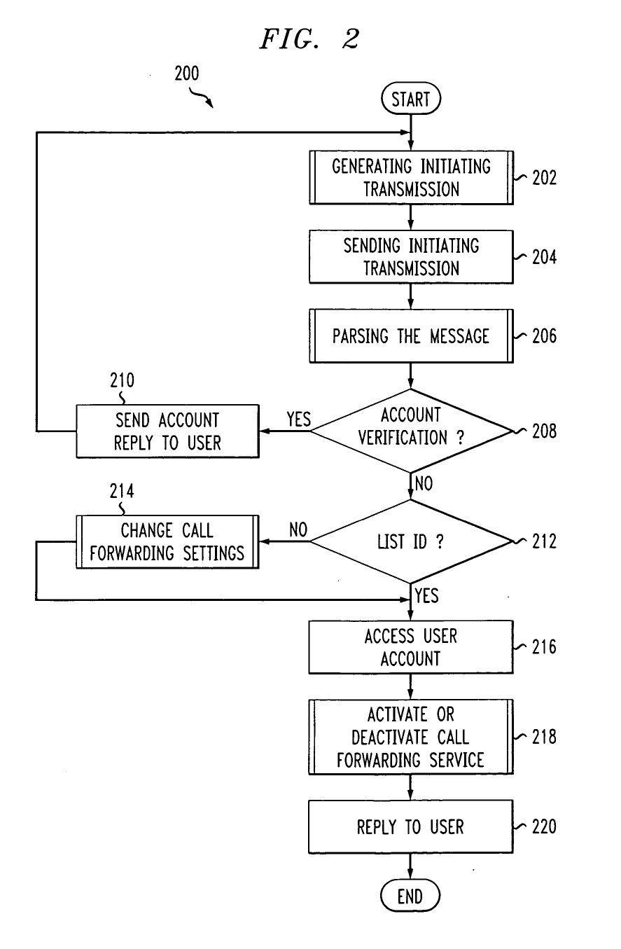

Referring now to FIG. 2, a method of configuration of call forwarding service is shown generally (at 200). It should be understood that the method may be implemented in a variety of software and hardware configurations. In one form, the software implementing the method of FIG. 2 resides in the corporate phone system. In another form, the software implementing the method of FIG. 2 resides in the service provider's network. In yet another form, at least a portion of the software implementing the method resides in the unified messaging server. In yet another, form the software implementing the method of FIG. 2 resides in the communication device itself. In still another form, the software may be distributed among any and/or all suitable network elements.

As shown, the method 200 includes generating and initiating transmission (at 202). This initiating transmission can be an e-mail, an SMS message with messaging text or any other acceptable initiating transmission. The text could include a variety of different formats. In one embodiment, the initiating transmission would include a time and/or date of beginning call forwarding. In another embodiment, the initiating transmission would include the time and/or date to end call forwarding. The initiating transmission could further include a list of phone numbers in which to forward the call. In which case, it could also include instructions on what order to call each number or if to dial all numbers simultaneously. Furthermore, the initiating transmission could include from what numbers the call would be forwarded. For example, the initiating transmission would include that calls from person A shall be forwarded to this number until further notice; however, all other calls are not to be forwarded. This could be particularly useful when forwarding calls includes a fee such as per use and/or long distance charges. In this instance, a person would only forward calls that that person would be willing to pay the prescribed fee for. The initiating transmission could further include a password value in order to verify the user is authorized to forward calls.

The method continues with the initiating transmission being sent to a receiving system (at 204). The message could be sent over a public network which would include a PSTN, a VolP network, the internet, etc. The message could go through the network provider or go directly to the corporate phone system.

The message is then parsed in order that it may be acted upon (at 206). Parsing the message includes dividing the message into its components with respect to a predetermined format. These components could include, but are not limited to, the telephone number in which the call will be forwarded, the originating number(s) which will trigger the forwarding, the password and/or pin, etc. Acting on the message could include opening up a java application in which to generate an interface for the user to communicate what phone number to forward the call to.

Another step in the method 200 is account verification (at 208). If account verification is necessary then the corporate phone system can send out a reply to the user. However, if account verification is not necessary, the system goes on to query if there is a list or a list identification included in the initiating transmission.

The initiating transmission could include a list or a list identification (at 212). A list would include numbers in which to forward calls and/or which telephone numbers originate a call would trigger the call forwarding settings. In one embodiment the initiating transmission would include a list of groups (for example, associate or directors, etc.) In this instance, the system could access a directory server in order to define these groups and obtain contact information for these groups. In another example, the list identification is not included in the initiating transmission.

If there is no list or list identification included, the call forwarding settings would be set to default which would be a predetermined number to forward the calls and a predetermined group of calls which would trigger the call forwarding settings (at 214).

The system would then access the user account (at 216) and from there the system would activate or deactivate call forwarding service (at 218).

Optionally, the system would reply to the user that the process has been completed successfully (at 220). Furthermore, the system could reply other information such as in what circumstances call forwarding will begin and/or end where the calls would be forwarded to, in what circumstances the calls would be forwarded. For example, calls could be forwarded after a certain number of rings.

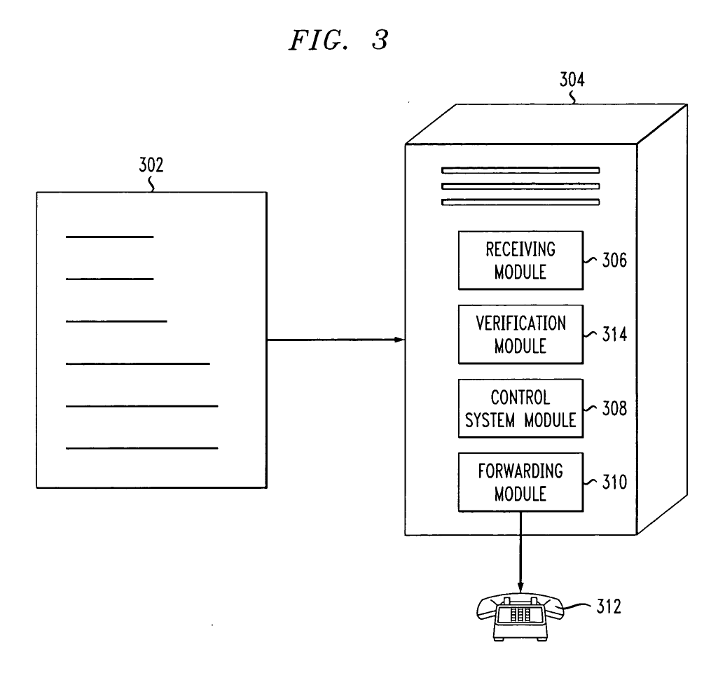

Now referring to FIG. 3, in this embodiment the system includes four modules; a receiving module 306, a verification module 314, a control system module 308 and a forwarding module 310. The system further includes a corporate phone system 304 and initiating transmission 302 and a second phone line 312. It should be noted that these modules can be implemented in a variety of different forms. Furthermore, these modules could exist in a variety of different hardware configurations. As stated before, the software could be implemented into a unified message server and/or the network provider. In this example, for illustrative purposes only, the corporate phone system houses these four modules.

The receiving module 306 receives the initiating transmission 302 which was sent to the corporate phone system 304. As noted above, the initiating transmission 302 could be a variety of different media and the receiving module 306 is configured to accept these different types of media.

Control system module 308 is configured to parse the initiating transmission 302 into components in order to determine the parameters of the call forwarding settings (FIG. 2, 206). One method of accomplishing this step is by configuring the control system module 308 to divide the initiating transmission into its different components. These components could include the phone number in which the call will be forwarded, the originating number that will trigger the call forwarding, the unifying messaging account which would receive the charge, an authentication password, a start time, and/or an end time, etc. However, if some or all of these of components are not in the initiating transmission, the method could further include opening a java application in which to query the user for the components.

The forwarding module 310 is configured to intercept calls that would normally be received by a user's first line and forward them to the user's second line 312. The circumstances in which these calls will be forwarded are outlined in the parameters set forth in the initiating transmission 302.

The path in which this call is forwarded can be set up through a variety of different networks, including a public network (PSTN), a VolP network, etc. The forwarding module 310 may also use presence information technology in order to find a user. In which case a user would simply have the call forwarded to a telephone that is within range. Furthermore, the forwarding module 310 could also use “find me” technology to forward the call. In this instance, the call would be forwarded to a list of numbers which would be dialed either in sequence or simultaneously until the user answers. There are other methods to forward a call, known to those skilled in the art.

A verification module 314 is also shown in FIG. 3. The verification module 314 is used in order to verify that the customer should have access to the call forwarding settings. The verification module 314 could include a system designed to accept access codes or use caller identification in order to ensure that the initiating transmission 302 is originating from a pre-approved line. The verification module 314 could also have access to a directory server in order to ensure that the calls being forwarded are participants in a pre-approved community. In another embodiment, the verification module 314 would have the means to communicate with the user in order to query with this type of information. This could include opening a web application in order to connect with the user.

The above description merely provides a disclosure of particular embodiments of the disclosure and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of configuration of call forwarding comprising:
receiving an initiating transmission from a user;
accessing an account that is associated with said user; and
altering the call forwarding settings of said account.

2. A method according to claim 1, further comprising replying to said user the status of said account.

3. A method according to claim 1, wherein altering the call forwarding setting of said account includes implementing find me features.

4. A method according to claim 1, wherein altering the call forwarding settings of said account includes implementing presence information.

5. A method according to claim 1, wherein receiving an initiating transmission from a user includes receiving a short messaging system message from a user.

6. A method according to claim 1, wherein receiving an initiating transmission from a user includes receiving an e-mail message from a user.

7. A method according to claim 1, wherein receiving an initiating transmission from a user includes receiving at least one time boundary for the call forwarding service.

8. A method according to claim 1,wherein receiving an initiating transmission from a user includes receiving at least one phone number or phone number identification where the call should be forwarded.

9. A method according to claim 1, further comprising verifying that said user is a subscriber.

10. A system for call forwarding configuration comprising:
a messaging server configured to receive an initiating transmission requesting an alteration of call forwarding service settings;
a control system module configured to parse said initiating transmission into components in order to determine parameters for said call forwarding feature; and
a forwarding module that alters said call forwarding service settings.

11. A system according to claim 10 wherein said initiating transmission is a short messaging system message.

12. A system according to claim 10 wherein said initiating transmission is an e-mail message.

13. A system according to claim 10, further comprising a verification module configured to authenticate said transmission.

14. A system according to claim 10, wherein said initiating transmission includes at least one phone number or phone number identification where the call should be forwarded.

15. A system according to claim 10, wherein said initiating transmission includes at least one time boundary for the call forwarding service.

16. A method for the configuration of call forwarding through short messing or e-mail comprising:
verifying an account associated with the sender of an initiating transmission, wherein said initiating transmission is configured to communicate purposed alterations of call-forwarding features;
parsing said initiating transmission into its components;
altering call forwarding settings according to the specifications outlined in said initiating transmission; and
replying to said sender that said account call forwarding setting have be altered.

17. A system for the configuration of call forwarding through an initiating transmission comprising:
a means for verifying an account associated with the sender of an initiating transmission, wherein said initiating transmission is configured to communicate purposed alterations of call forwarding features;
a means for parsing said initiating transmission into its components; and
a means for altering call forwarding settings according to the specifications outlined in said initiating transmission;

18. A system according to claim 17 wherein said initiating transmission is an e-mail message.

19. A system according to claim 17 wherein said initiating transmission is a short messaging system message.

20. A system according to claim 17 further comprising a means for replying to said sender that said account call forwarding setting have be altered.
